(19) United States
(12) Patent Application Publication
(10) Pub. No.: US 2015/0209708 A1
(43) Pub. Date: Jul. 30, 2015

(54) Flexible Air Filter Assembly

(71) Applicant: Edward ORDAKOWSKI, Sterling Heights, MI (US)

(72) Inventor: Edward ORDAKOWSKI, Sterling Heights, MI (US)

(21) Appl. No.: 14/607,668

(22) Filed: Jan. 28, 2015

Related U.S. Application Data
(60) Provisional application No. 61/932,492, filed on Jan. 28, 2014.

(51) Int. Cl. B01D 46/00

(52) U.S. Cl. CPC B01D 46/0005

(57) ABSTRACT

An air filter assembly is provided having a first end plate defining an air inlet and a slot, and a second end plate defining an air outlet. A flexible duct is disposed between the first and second end plates. A rectangular filter angularly disposed between the first and second end plates and supported by the first and second surfaces. The flexible duct can be a tube formed of one of a coated fabric and a polymer sheet.

### CROSS-REFERENCE TO RELATED APPLICATIONS

This application claims the benefit of U.S. Provisional Application No. 61/932,492, filed on Jan. 28, 2014. The entire disclosure of the above application is incorporated herein by reference.

### FIELD

The present disclosure relates to an air filter design and, more particularly, to a filter for a forced air system having an impermeable flexible duct.

### BACKGROUND

This section provides background information related to the present disclosure which is not necessarily prior art.

In many instances it is desirable to remove some or all of the particulate material from a gas flow. For example it may be desirable, to clean air intake streams for housing systems or green houses. It is therefore preferred, for such systems, to remove the particulate material from the gas flow upstream of a living space or a green house. A variety of air cleaner arrangements have been developed for particulate removal.

Often greenhouse growers utilize high-power halogen light fixtures to provide necessary light to grow plants during off-season periods of the calendar year. These lighting fixtures require cooling to prevent damage to the plants or lighting fixtures. Often, this cooling utilizes forced air over light emitting members to reduce heat from the growing system. Unfortunately, dust collects within the light fixtures. This dirt often collects on light emitters or glass surfaces which decrease a light fixture's output and increases heat retention. This problem is so pervasive that regularly scheduled maintenance must be conducted to clean surfaces within the light fixtures.

### SUMMARY

This section provides a general summary of the disclosure, and is not a comprehensive disclosure of its full scope or all of its features.

According to another teaching of the present disclosure, a non-permeable flexible duct is provided. Coupled to the flexible duct is a first end plate member defining an air inlet and a filter inlet, the flexible duct further is coupled to a second end plate defining an air outlet. The first and second end plate members define filter support members within the cavity. Disposed on the support member are the filter support members.

According to the present teachings, the filters described above can have a plurality of support members disposed between the first and second end plate members. According to another teaching, an air filter assembly is provided having a first end plate defining an air inlet and a slot, and a second end plate defining an air outlet. A flexible duct is disposed between the first and second end plates. A rectangular filter angularly disposed between the first and second end plates and supported by the first and second surfaces. The flexible duct can be a tube formed of one of a coated fabric and a polymer sheet.

According to another teaching, a plurality of support rods coupled at a first end to the first end plate and a second end to the second end plate are used to apply force to the first and second end plates and to place the flexible duct in tension. Optionally, the first end plate has an annular flange disposed about the air input aperture. Additionally, the first end plate defines a peripheral flange sealably coupled to the flexible duct.

According to the present teachings, a filter assembly is provided. The filter assembly has a first rectangular prism plate having a first flange disposed adjacent to a periphery of the first rectangular prisms the plate defining an air input aperture. The filter also has a second rectangular prism plate having a second flange disposed adjacent to a periphery of the second rectangular prism, the second rectangular prism defining an air output aperture. A flexible rectangular conduit defining a through passage between first and second ends is provided. A rectangular filter disposed within the through passage and angularly and fluidly disposed between the air input aperture and the air output aperture.

According to another teaching, the first rectangular prism plate defines a slot configured to slidably accept and support the rectangular filter element. Optionally, the first and second prismatic plates have filter support flanges that are angularly coupled to the first and second prism. The first end adhesively coupled to the first flange, while the second end can be adhesively coupled to the second end. The flexible rectangular conduit can define a plurality of fabric loops which accept support rods disposed between the end plates.

According to the present teachings, a lighting system is provided having a light emitting element. The light fixture has an enclosed cavity having an air input and an air output. Fluidly coupled to this air input is a filter structure. The air filter structure has a pair of solid end plates. Disposed between the solid end plates is a fluidly impervious fabric duct which defines a cavity. Disposed within the cavity is a filter structure configured to filter air passing through the cavity.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 represents an exploded view of the flexible filter according to the present teachings;

FIG. 2 represents an assembled view of the flexible filter according to the present teachings;

FIG. 3 represents a side view of the filter shown in FIGS. 1 and 2;

FIG. 4 represents a perspective view of the filter shown in FIGS. 1-3 with a flexible duct member removed;

FIG. 5 represents a perspective view of the flexible filter shown in FIGS. 1-4;

FIGS. 6A-6G represent views of the filter shown in FIGS. 1-5;

FIGS. 7A-7F represent views of a first end plate according to the present teachings;

FIGS. 8A-8G represent views of a second end plate according to the filters shown in FIGS. 1-6G;

FIGS. 9A-9D represent a filter element according to the present teachings;

FIGS. 10A-10C represent a flexible duct according to the present teachings;

FIGS. 11A and 11B Perspective views of a filter assemble;

FIG. 12 represents a side view of a filter assembly;

FIG. 13 represents a filter coupled to a flexible duct and fan;

FIG. 14 represents a perspective exploded view of a second filter assembly;

FIG. 15 represents a side view of a second filter assembly coupled to a housing structure;

FIGS. 16 and 17 represent side views of a second filter view of a second filter assembly according to the present teachings;

FIG. 18 represents an end view of a second filter assembly coupled to a housing structure; and

FIG. 19 represents a view of the filter structures in a collapsed configuration.

Corresponding reference numerals indicate corresponding parts throughout the several views of the drawings.

### DETAILED DESCRIPTION

Example embodiments will now be described more fully with reference to the accompanying drawings.

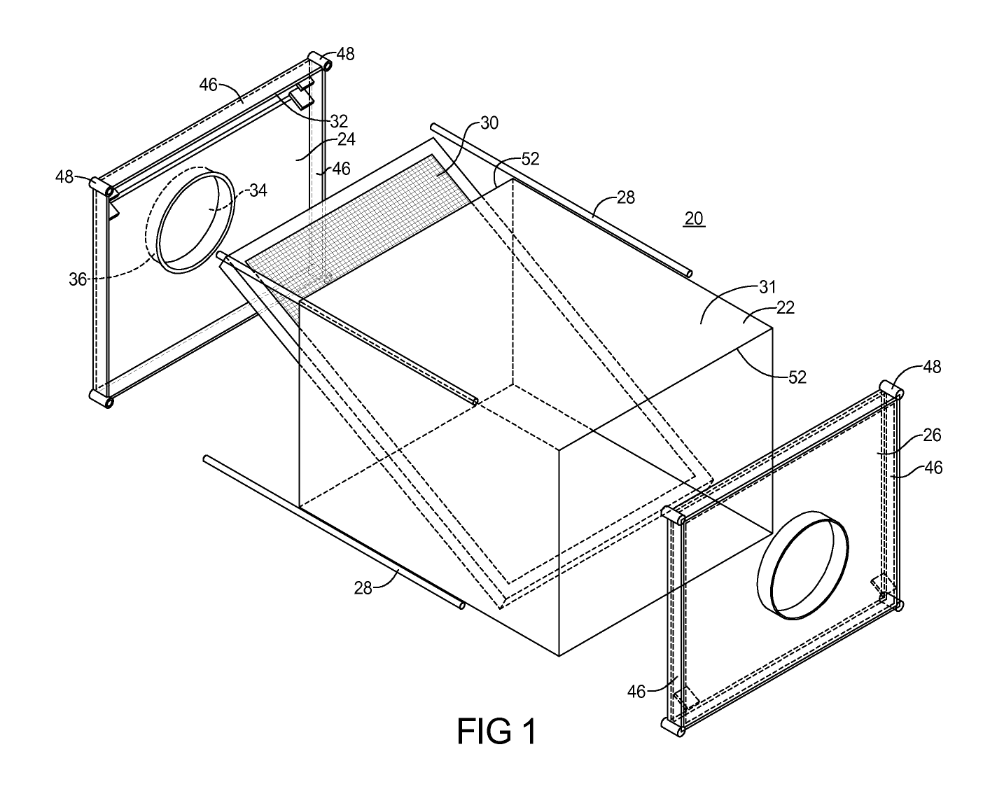

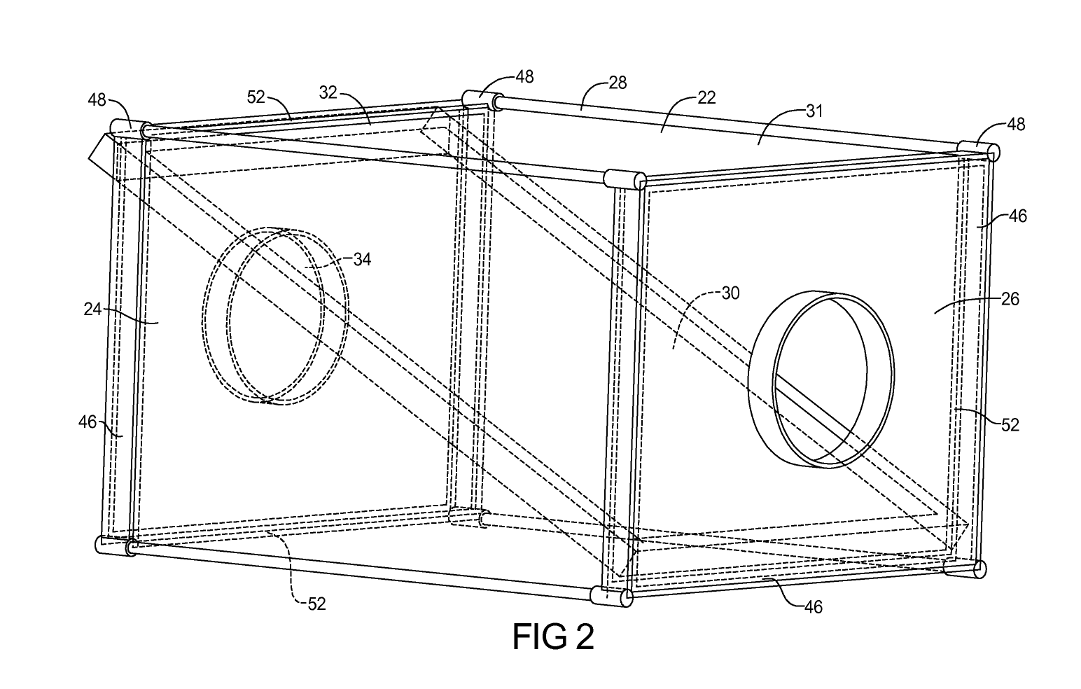

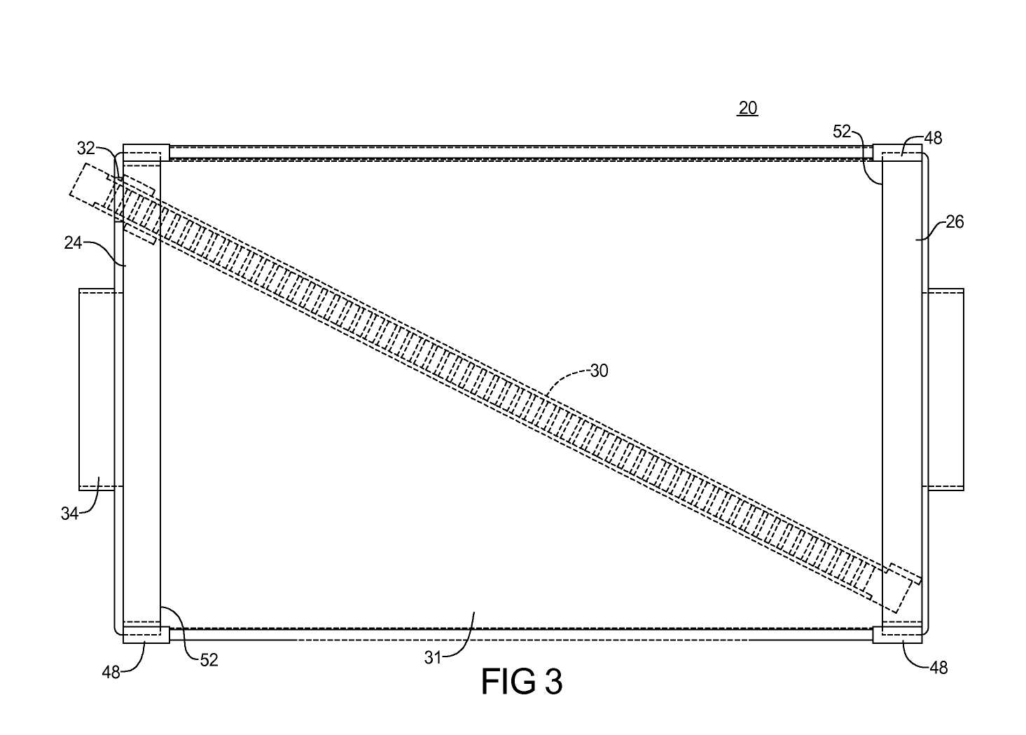

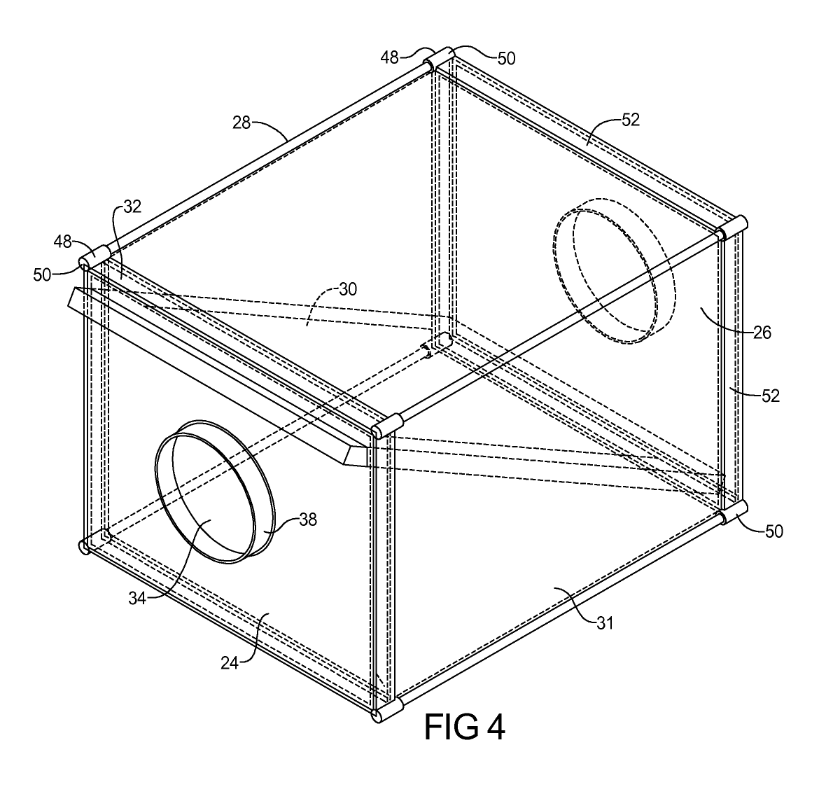

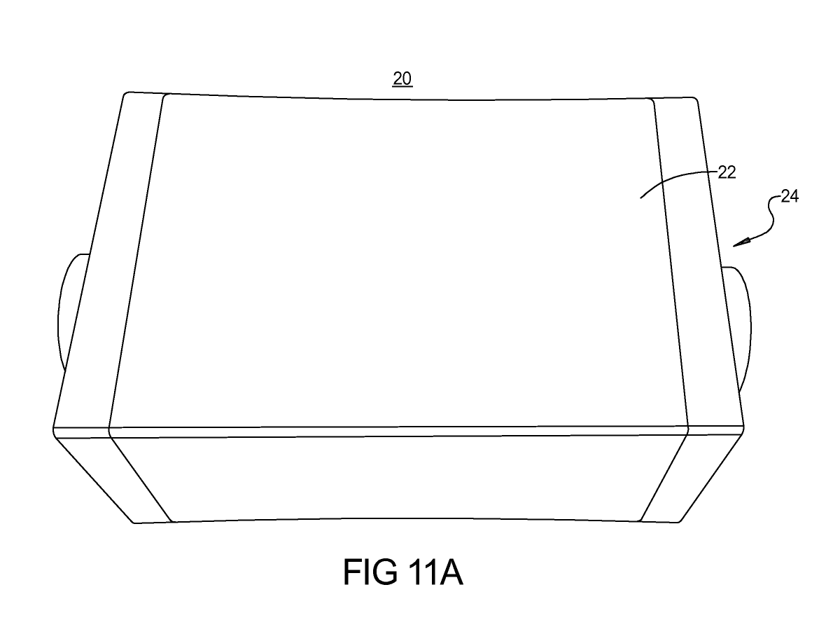

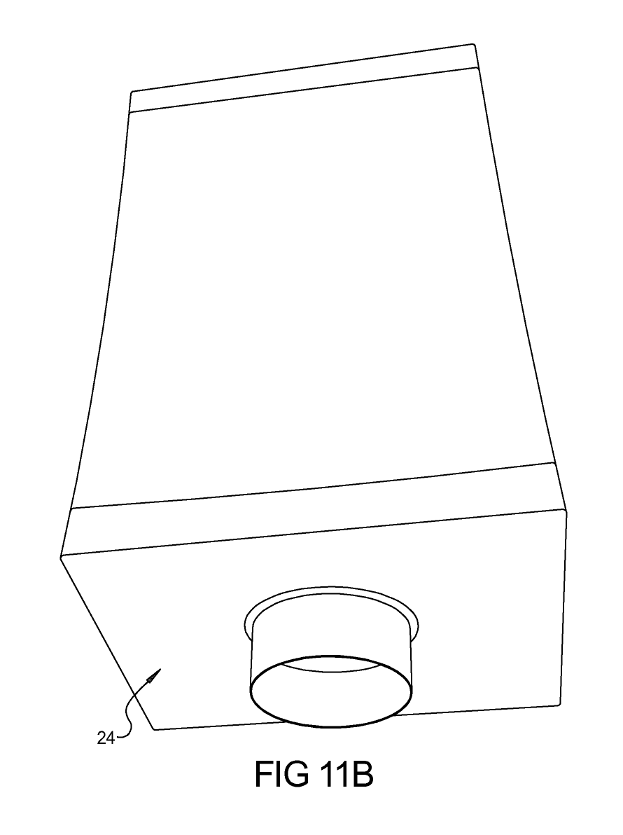

With reference to FIGS. 1-13, shown is a filter system 20 according to the present disclosure. The filter system can be formed of five general components. These include a flexible duct portion 22, a first end plate 24, a second end plate 26, a support system 28, and a removable filter cartridge 30.

The filter system 20 defines an internal cavity 32 which removably accepts the removable filter cartridge 30. The internal cavity 31 is defined between the first and second end plates 24, 26 and within the flexible duct portion 22. As can be seen, the cavity 32 is generally prismatic in shape. This shape is supported by the support system 28 which holds the first and second end plates 24, 26 apart in tension, thus stretching the flexible duct portion 22.

FIG. 1 represents an exploded view of the flexible filter according to the present teachings. The first end plate 24, which is a rectangular prism, is configured to slidably accept the filter cartridge 30 within an optional slot 32 defined in the first end plate 24. The end plate 24 also defines a circular air input aperture 34. Both the slot 32 and circular air input aperture 34 have support flanges 36 and 38.

The support flange 36 for the filter slot 32 can be defined on a first slide 40 of the first end plate 24. The second slide 42 of the first end plate 24 can support the circular support flange 38 disposed around the circular air input aperture 34. The circular support flange 38 is configured to accept a standard 4″ air vent duct. Optionally, the filter 30 can be inserted into the internal cavity through a closable slot 33 formed in the soft flexible duct portion 22. The closable slot can include a zipper or opposed hook and loop fasteners such as Velcro™.

Disposed about the perimeter of the first end plate 24 is a plurality of side support flanges 46. Positioned at the interface between the support flanges 46 and at the corners of the end plates can be a plurality of support member coupling structures 48. The support structures 48 can be for instance tubular members 50 defining an aperture 51 configured to support and couple to members 54 that make up the support system 28.

In this embodiment, the flexible duct portion 22 is coupled to the side support flanges 46. In this regard, edges 52 of the flexible duct portion 22 are mechanically or adhesively coupled to side support flanges 46. The flexible duct 22 can be formed of a polymer sheet or a coated fabric. The flexible duct portion 22 can be coupled to a slot, using compression or fasteners, defined in the flange. Preferably, the edge 52 to support flange 46 interface should be fluidly sealed so that air pressure passing through the circular input aperture 34.

The support system 28 has a plurality members 54 disposed within the support coupling structures 48. The members 54 can be, for instance, fiberglass rods 60. The rods 60 can be fed through tubular portions 62 sewn into the flexible duct portion 22. Alternatively, the duct portion 22 can be coupled to the fiberglass rods 66 using clips (not shown).

The length of the fiberglass rod 60 can be set so they need to be flexed prior to insertion of the rod 60 into the support member coupling structures 48. This configuration provides separating forces onto the end plates, placing tension on the flexible duct portion 22.

As shown in FIGS. 1-18, the optional filter cartridge 30 can be angularly disposed across the cavity 31 formed between the first and second end plates 24, 26. In this position, the filter cartridge 30 physically divides the cavity and separates the air input and output while allowing air flow there between. The filter can be inserted into the cavity through the closable slot 33 or the slot defined in the solid ends 24, 26.

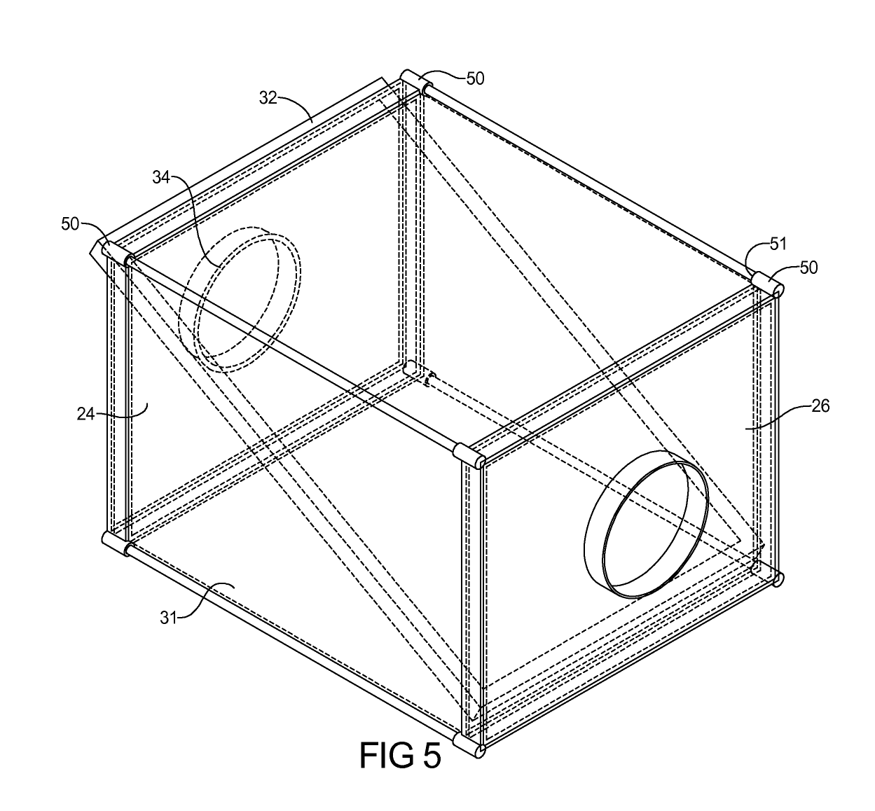

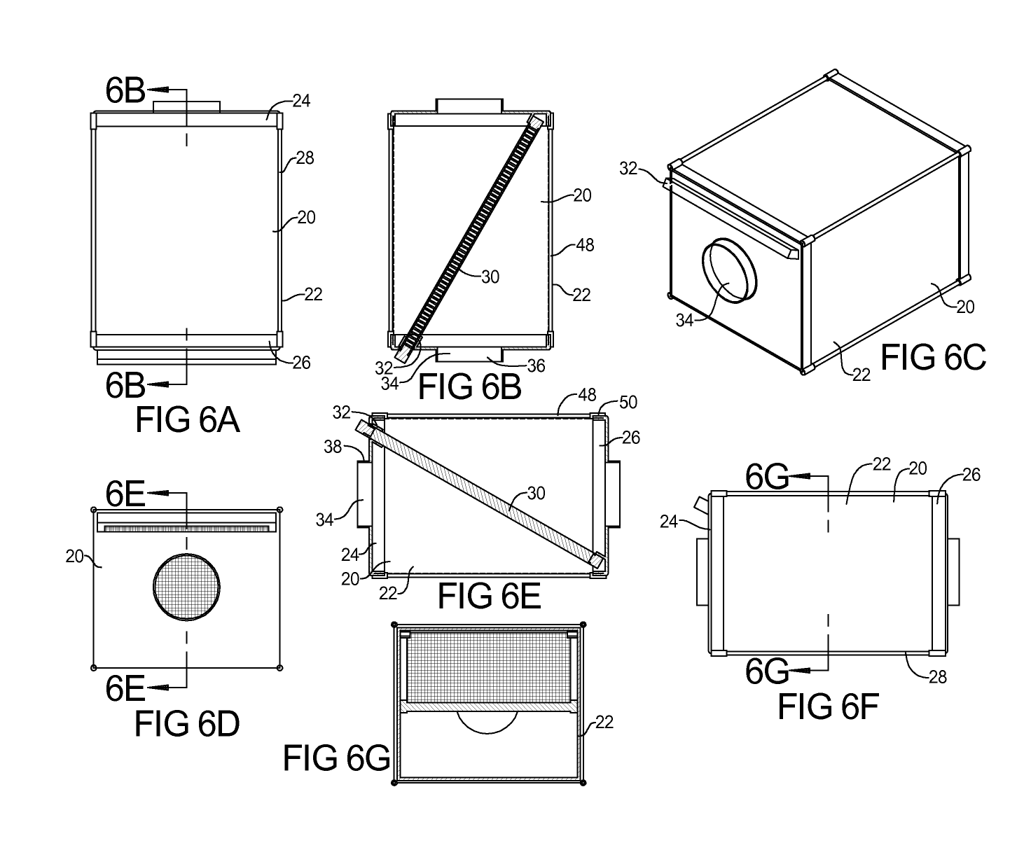

FIGS. 6A-6F present various views of the filter assembly shown in FIG. 1. Specifically shown are the relation of the bearing surfaces of the first and second endplates 24,26 and the support flanges 36 and 70 as well as the filter cartridge 30.

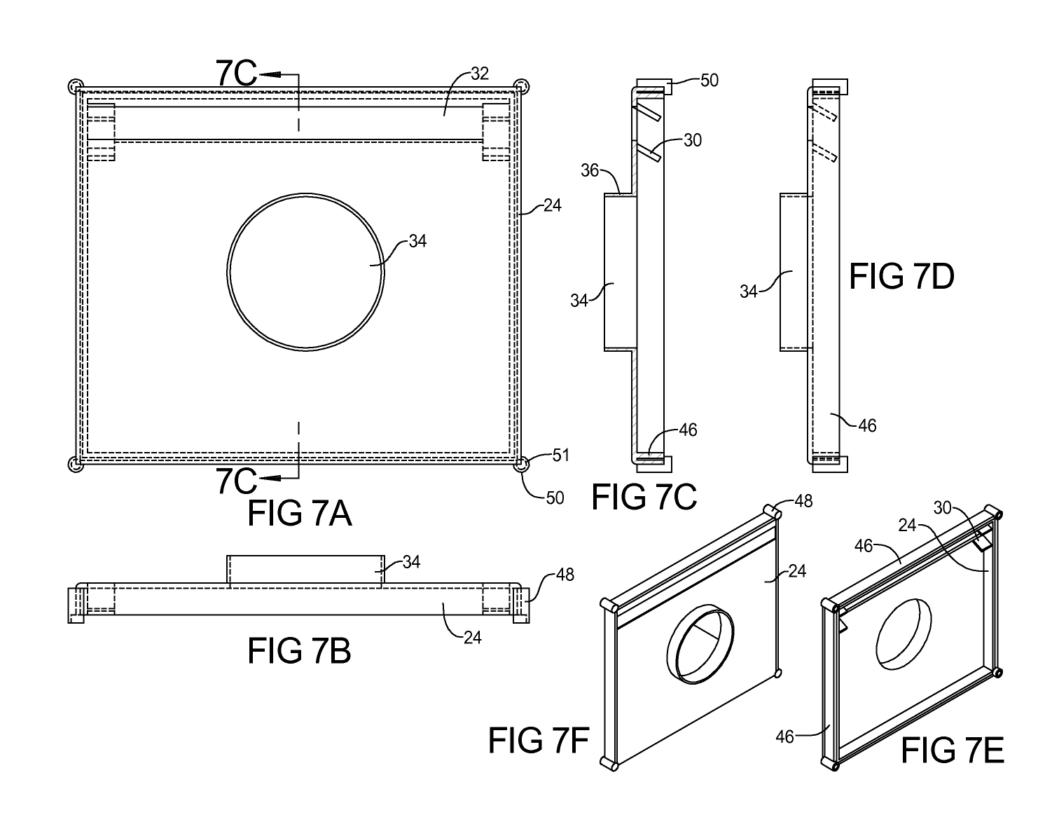

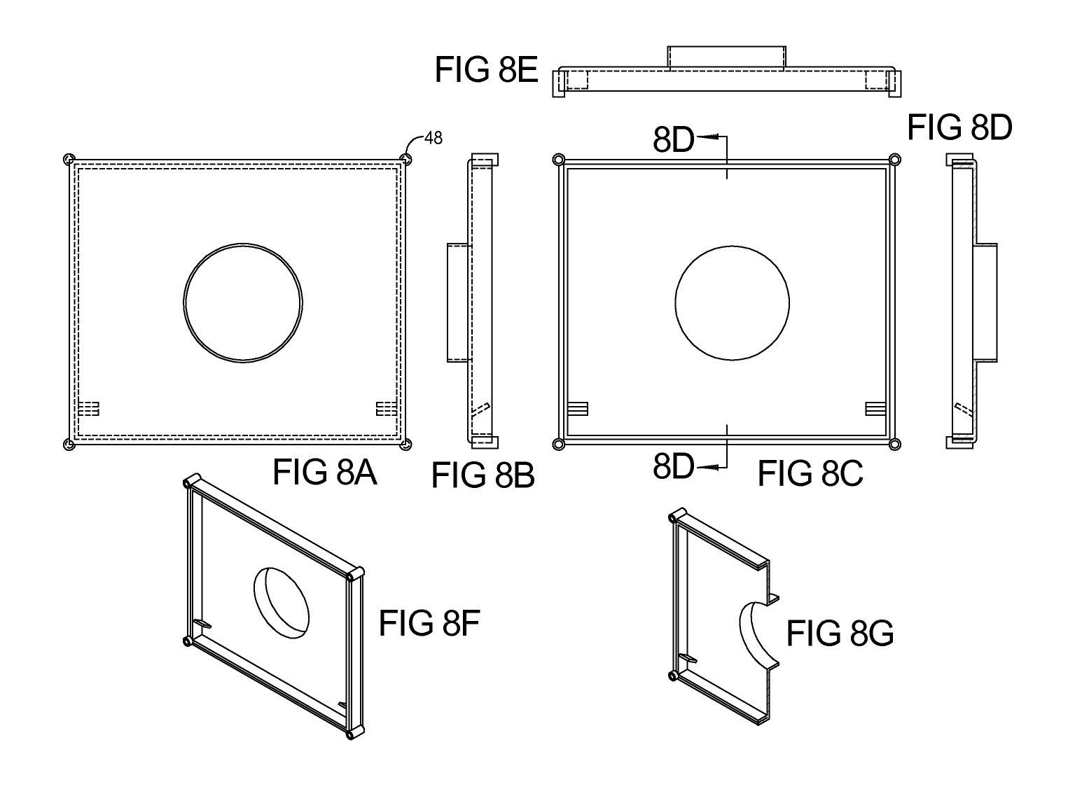

FIGS. 7A-8G represent views of the first and second endplates. The end plates 24, 26 include a planar body portion which defines an input aperture 34 or and output aperture. Also shown is peripheral support flanges having bearing surfaces and annular support flanges 38. The coupling structure for the Rods can be positioned so that the Rods can be found within or outside of the flexible duct portion 22.

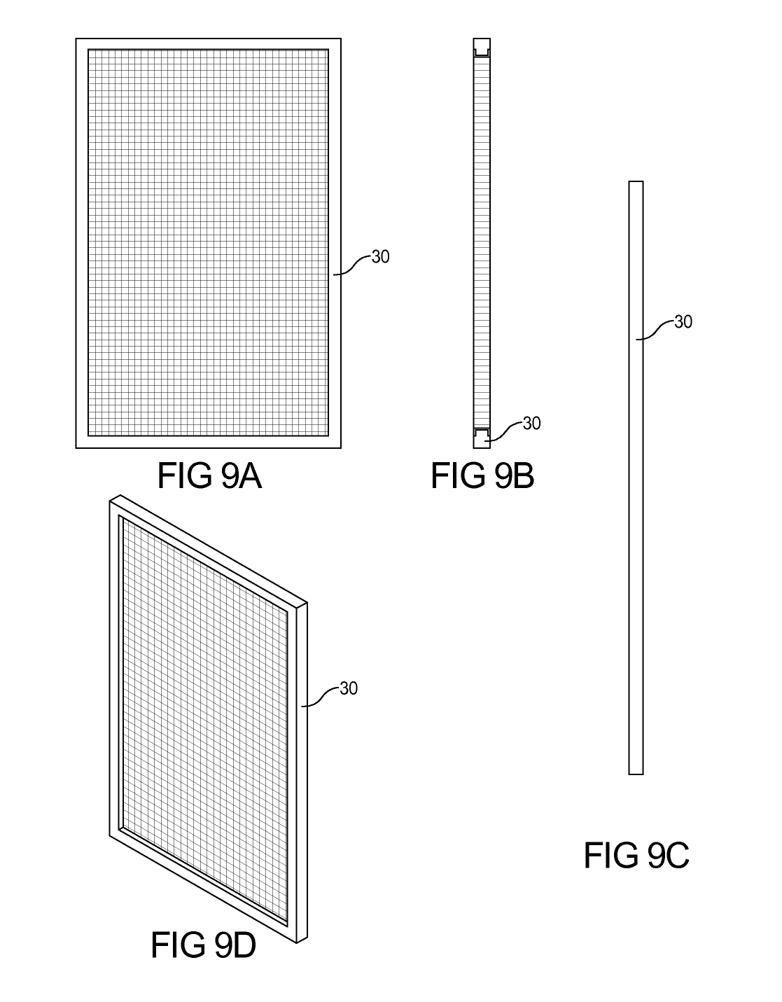

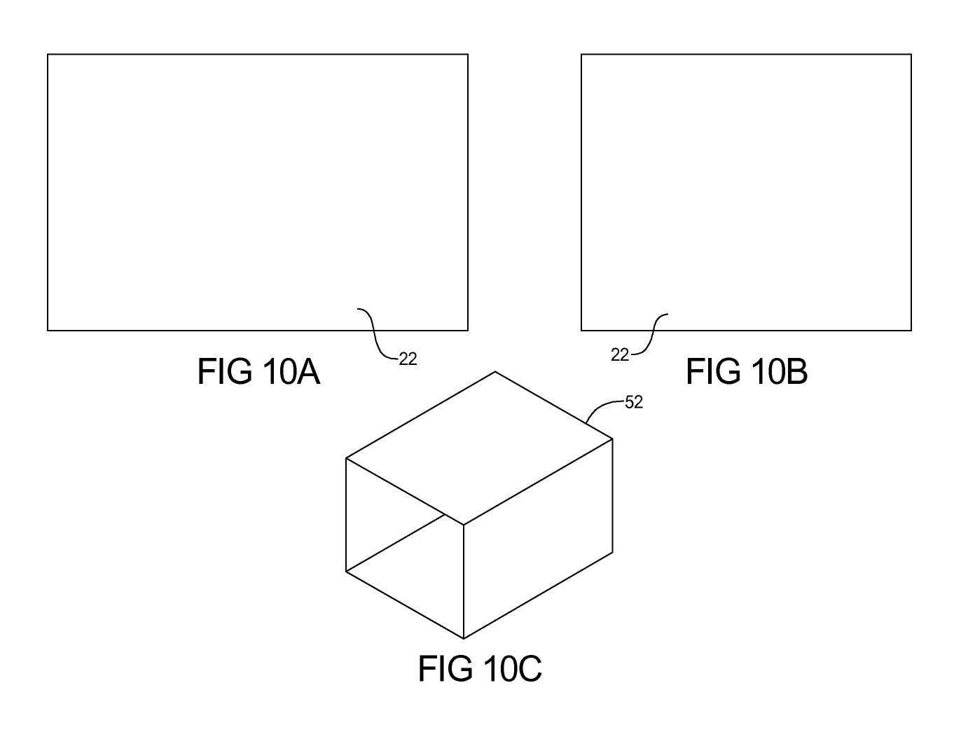

FIGS. 9A-9D represent replaceable rectangular filter cartridges 30 according to the teaching of the present invention. As shown in FIGS. 10A-12, the flexible duct portion can have a square cross section, formed of one of an uncoated fabric, coated fabric, and a polymer sheet. The ends of the polymer sheet are fastened to the first and second end plates 24, 26.

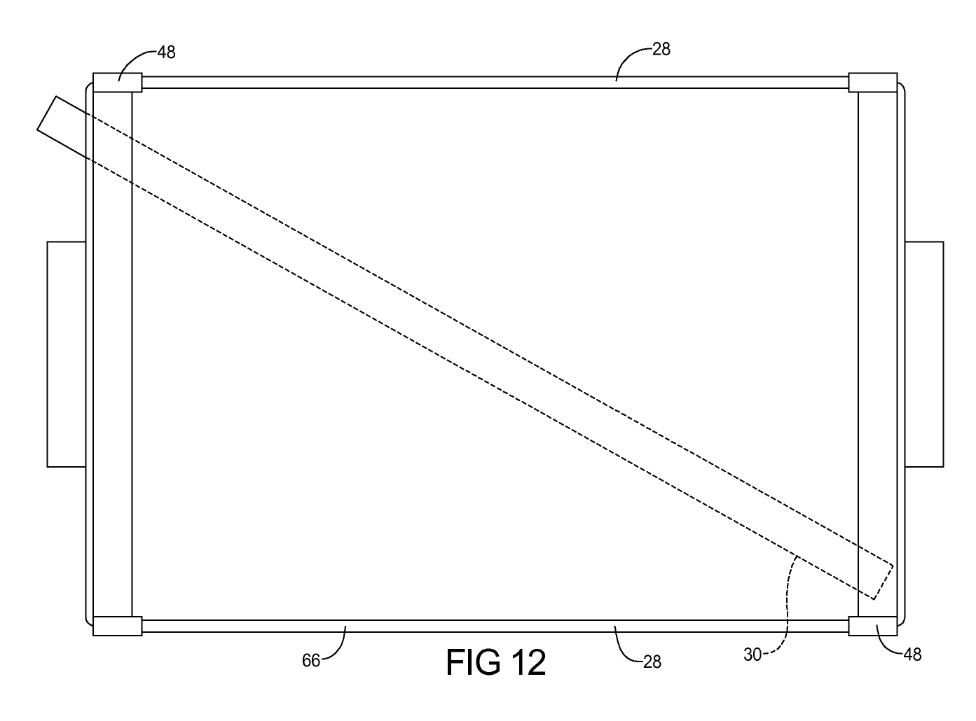

As shown in FIG. 12, the filter 30 can be supported by the first end plate and at least one flange 70 defined on an inner surface of the second end plate 26. The support flanges 36 and 70 have support surfaces 72 which support the frame of the filter cartridge 30.

Edges 74 on the frame of the filter cartridge 30 are positioned in contact with the sides of the flexible duct portion 22. The filter cartridge 30 can be a standard filter cartridge used in furnace systems. The filter cartridge can be angles between about 20 and 80 degrees with respect to the end plate.

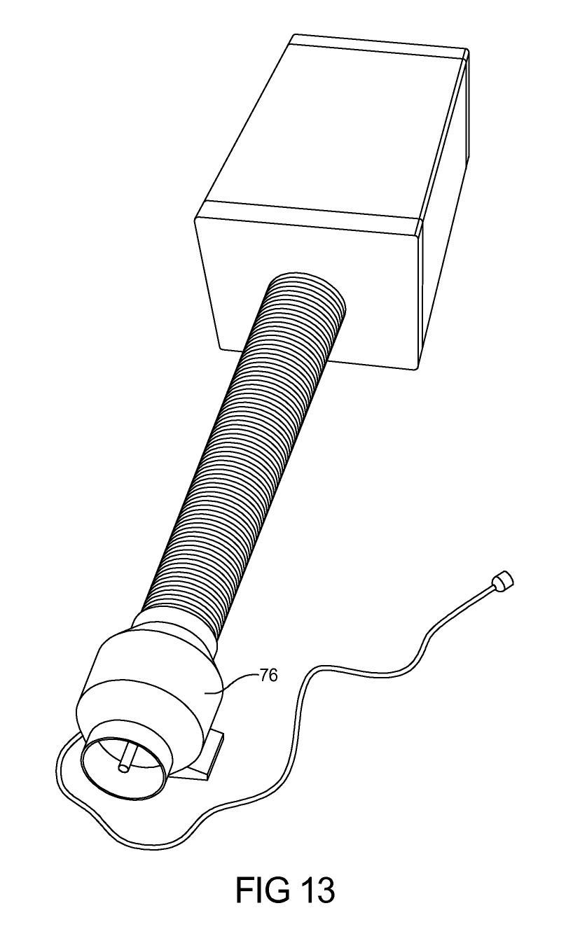

FIG. 13 represents the filter assembly coupled to a flexible duct 78 and a fan 76. Although not shown, a second flexible duct can be coupled with a hose clamp (not shown) to the circular air aperture formed in the second end plate 26. This second flexible duct can be coupled to electronic components such as lamps or equipment which need a constant air flow as described above.

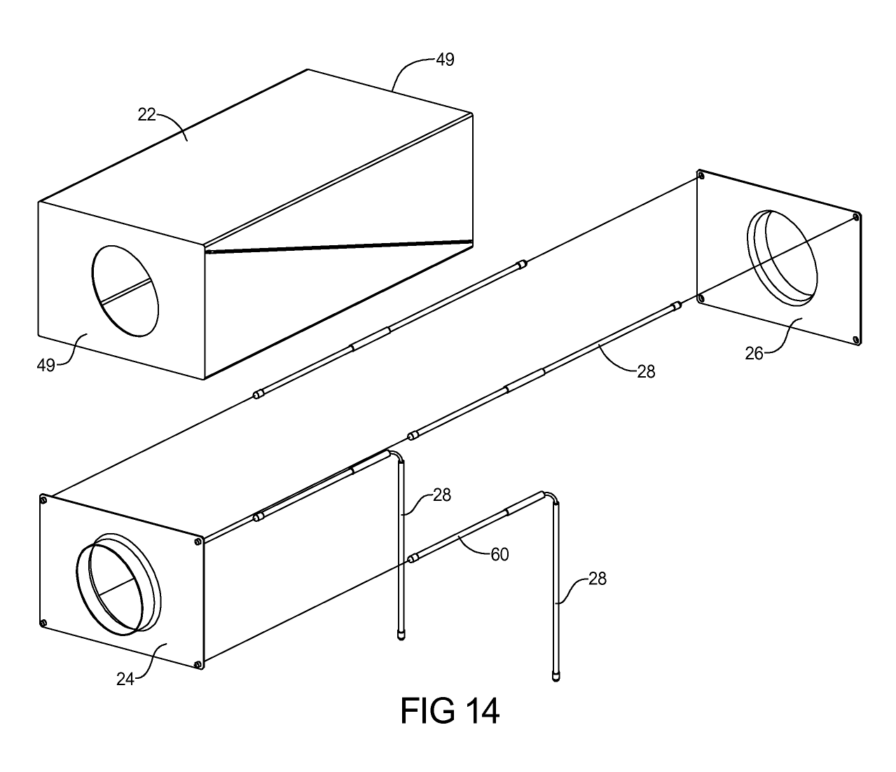

FIG. 14 represents an exploded view of an alternate flexible filter according to the present teachings. The first end plate 24, which is a rectangular prism, is configured to slidably accept the filter cartridge 30 within an optional slot 32 defined in the flexible conduit portion 22. The end plate 24 also defines a circular air input aperture 34 having a support flange 36.

The support flange 36 for the filter slot 32 can be defined on a first slide 40 of the first end plate 24. The second slide 42 of the first end plate 24 can support the circular support flange 38 disposed around the circular air input aperture 34. The circular support flange 38 is configured to accept a standard 4″ air vent duct. Optionally, the filter 30 can be inserted into the internal cavity through the closable slot 33 formed in the soft flexible duct portion 22. The closable slot can include a zipper or opposed hook and loop fasteners such as Velcro™.

Disposed about the perimeter of the first end plate 24 can be a plurality of side support flanges 46. Positioned at the interface between the support flanges 46 and at the corners of the end plates can be a plurality of support member coupling structures 48. The support structures 48 can be for instance tubular members or depressions 50 defining an aperture 51 configured to support and couple to members 54 that make up the support system 28.

In this embodiment, the flexible duct portion 22 is coupled to the first and second end plates are disposed within the flexible duct portion 22. In this regard, edges 52 of the flexible duct portion 22 are mechanically or adhesively coupled to a pair of end panels. The flexible duct 22 can be formed of a polymer sheet or a coated fabric.

As shown in FIGS. 1-18, the air filter assembly 20 has a first end plate defining an air inlet and having a first supporting surface. A second end plate can define either an air outlet or air inlet, and has a second support surface. The support surfaces 47 are configured to support a rectangular filter element, and can be a plane defined at a first angle between 80 and 20 degrees with respect to the air flow path. The first end plate comprises an annular flange 36 disposed about the air input aperture and a peripheral flange engaged with the flexible duct. Disposed at the intersection of the peripheral flanges 36, 46 can be coupling mechanisms, for example tubes, configured to accept support rods. The flexible duct is disposed between the first and second end plates and defines a rectangular prismatic cavity.

A support frame 28 is disposed between the first and second end plates so as to place the flexible duct portion 22 in tension. The support frame 28 comprises a plurality of support rods each coupled at a first end to the first end plate and a second end to the second end plate. These rods can contain bamboo or fiberglass. As shown in FIG. 14, the first and second end plates can be positioned within a pair of end panels 49 stitched to the flexible duct portion 22. Optionally, the end plates 24, 26 can define exterior endcaps of the flexible duct. The rectangular flexible conduit defines a through passage between first and second ends, said first end being coupled to the first support surface, said second end being coupled to the second support surface. A rectangular filter angularly can be disposed between the first and second end plates and within the flexible duct portion 22, and supported across an airflow path between the first and second supporting surfaces. The filter cartridge 30 can be inserted into a slot defined in one of the endplates or in the side of the flexible duct. The first rectangular prism support defines a peripheral flange configured to support the rectangular filter element.

The first and second prismatic supports have filter support flanges. The filter support flanges are angularly coupled to the first and second prismatic supports so as to support and angularly dispose the rectangular filter across an airflow path between the air input aperture and the air output aperture. The filter assembly has a flange annularly disposed about the air input aperture. The first end of the flexible duct is adhesively coupled to the first support surface. The flexible rectangular conduit is selected from the group formed of one of a coated cloth, a polymer film, uncoated cloth, and combinations thereof.

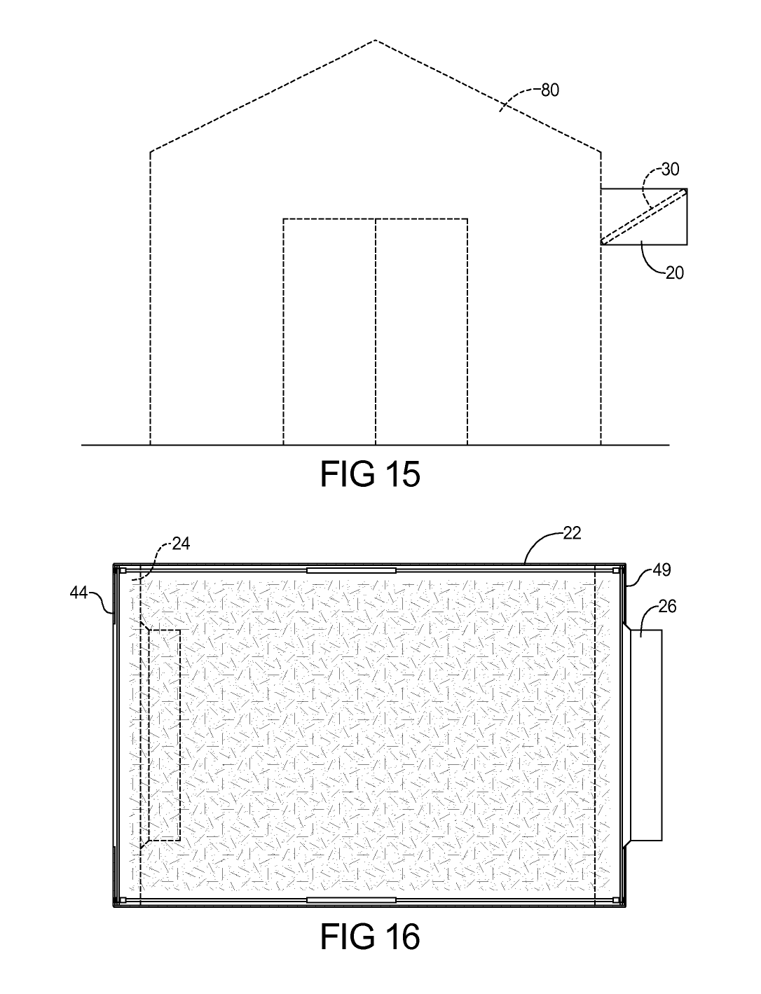

FIG. 15 depicts an air filter coupled to an exterior surface of a housing structure. Optionally, the filer system 20 can be sewn directly to a fabric housing structure such as a tent 80. As shown in FIG. 16 the air filter assembly has a first internal rectangular prism support having a first support surface disposed adjacent to a periphery of the first rectangular prism support said first rectangular prism support defining an output aperture. The filter assembly further has a second rectangular prism support having a second support surface disposed adjacent to a periphery of the second rectangular prism. A rectangular flexible conduit 22 defines a through passage between first and second ends. The rectangular flexible conduit 22 can be formed of an air permeable material, said first end being coupled to the first support surface, said second end being coupled to the second support surface. A second support 28 can internal support bars disposed between the first rectangular prism support and the second rectangular prism support. The second support configured to place the rectangular flexible conduit in tension and to resist relative rotation of the first rectangular prism with respect to the second rectangular prism. Optionally, the rectangular flexible conduit defines a chamber comprising a filter material. The endplate has a support flange disposed about the output aperture.

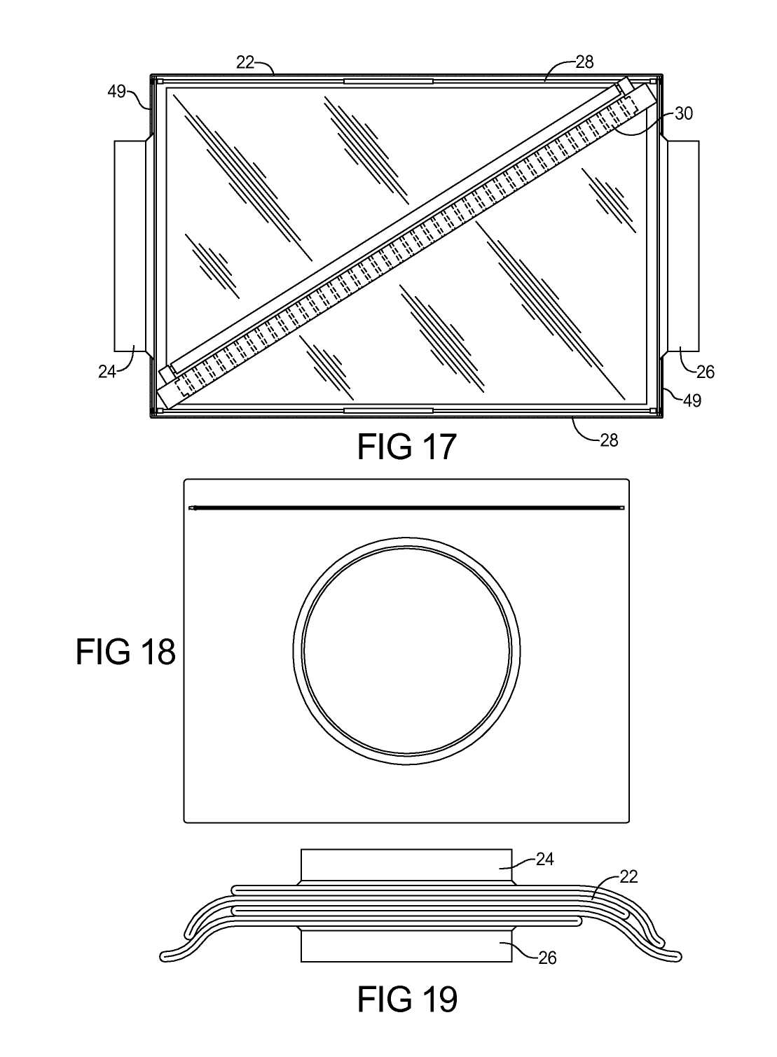

As shown in FIG. 17, a disinfecting UV lamp can be inserted into the filter's chamber to neutralize Fungal and Bacterial pathogens. As shown in FIG. 18, the filter cartridge can be inserted into the filter cartridge through a zipper formed in the end panel. As shown in FIG. 19, when the support rods are removed, the filter system is collapsible. Insertion of the rods 28 allows for the expansion of the filter system.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An air filter assembly comprising:
a first end plate defining an air inlet, said first end plate having a first supporting surface;
a second end plate defining an air outlet, said second end plate having second support surface;
a flexible duct disposed between the first and second end plates defining a rectangular prismatic cavity;
a support frame disposed between the first and second end plates so as to place the flexible duct in tension; and
a rectangular filter angularly disposed between the first and second end plates and within the flexible duct, and supported across an air flow path between the first and second supporting surfaces.

2. The air filter according to claim 1, wherein the flexible duct is a tube formed of one of an uncoated fabric, coated fabric, and a polymer sheet.

3. The air filter according to claim 1, wherein the support frame comprises a plurality of support rods each coupled at a first end to the first end plate and a second end to the second end plate.

4. The filter according to claim 3, wherein the plurality of rods are reinforced rods selected from a group consisting of bamboo and fiberglass.

5. The filter according to claim 1, wherein the first end plate comprises an annular flange disposed about the air input.

6. The filter according to claim 1, wherein the first end plate defines a peripheral flange engaged with the flexible duct.

7. The filter according to claim 6, wherein the first end plate is disposed within the flexible duct.

8. The filter according to claim 1, wherein the first supporting surface is a plane defined at a first angle between 80 and 20 degrees with respect to the air flow path.

9. The filter according to claim 1, wherein the flexible duct is a rectangular prism having first and second ends and wherein the first and second ends respectively engage the first and second end plate.

10. A flexible filter assembly comprising:
a first rectangular prism support having a first support surface disposed adjacent to a periphery of the first rectangular prism support said first rectangular prism support defining an air input aperture;
a second rectangular prism support having a second support surface disposed adjacent to a periphery of the second rectangular prism said second rectangular prism support defining an air output aperture;
a rectangular flexible conduit defining a through passage between first and second ends, said first end being coupled to the first support surface, said second end being coupled to the second support surface;
a rectangular filter disposed within the through passage and angularly and fluidly disposed between the air input aperture and the second rectangular prism support; and
a second support disposed between the first rectangular prism support and the second rectangular prism support, the second support configured to place the rectangular flexible conduit in tension and to resist relative rotation of the first rectangular prism with respect to the second rectangular prism.

11. The filter assembly according to claim 10, wherein the first rectangular prism support defines a peripheral flange configured to support the rectangular filter.

12. The filter assembly according to claim 10, wherein the first and second prismatic supports have filter support flanges.

13. The filter assembly according to claim 12, wherein the filter support flanges are angularly coupled to the first and second prismatic supports so as to support and angularly dispose the rectangular filter across an airflow path between the air input aperture and the air output aperture.

14. The filter assembly according to claim 10, comprising a flange annularly disposed about the air input aperture.

15. The filter assembly according to claim 10, wherein the first end is adhesively coupled to the first support surface.

16. The filter assembly according to claim 10, wherein the flexible rectangular conduit is formed of a material selected from the group of a coated cloth, a polymer film, uncoated cloth, and combinations thereof.

17. The filter assembly according to claim 10, wherein the flexible rectangular conduit comprises a plurality of external loops.

18. A flexible filter assembly comprising:
a first rectangular prism support having a first support surface disposed adjacent to a periphery of the first rectangular prism support said first rectangular prism support defining an output aperture;
a second rectangular prism support having a second support surface disposed adjacent to a periphery of the second rectangular prism;
a rectangular flexible conduit defining a through passage between first and second ends, said rectangular flexible conduit being formed of an air permeable material, said first end being coupled to the first support surface, said second end being coupled to the second support surface; and
a second support disposed between the first rectangular prism support and the second rectangular prism support, the second support configured to place the rectangular flexible conduit in tension and to resist relative rotation of the first rectangular prism with respect to the second rectangular prism.

19. The filter assembly according to claim 18, wherein the rectangular flexible conduit defines a chamber comprising a filter material.

20. The filter assembly according to claim 18, further comprising a support flange disposed about the output aperture.
